(19) United States
(12) Patent Application Publication
(10) Pub. No.: US 2013/0201204 A1
(43) Pub. Date: Aug. 8, 2013

(54) Method And Device For Implementing A Generic Icon With Multiple Display Modes

(71) Applicant: Zhiyun LI, Shenzhen (CN)

(72) Inventor: Zhiyun LI, Shenzhen (CN)

(73) Assignee: TENCENT TECHNOLOGY (SHENZHEN) COMPANY LIMITED, Shenzhen (CN)

(21) Appl. No.: 13/826,902

(22) Filed: Mar. 14, 2013

Related U.S. Application Data
(63) Continuation of application No. PCT/CN2012/070524, filed on Jan. 18, 2012.

(30) Foreign Application Priority Data
Jan. 27, 2011 (CN) 201110032532.X

(51) Int. Cl. G06T 11/00

(52) U.S. Cl. CPC G06T 11/001
USPC 345/592

(57) ABSTRACT

A method and device for implementing a generic icon with multiple display modes. An original image icon in a Bitmap format is preset, translucent processing is performed on the original image icon according to preset display modes, mask layer icons satisfying requirements of each of the display modes are obtained, the original image icon and the mask layer icons obtained by translucent processing are encapsulated into a skin installation package, and the skin installation package is sent. The number of the images in the skin installation package, and the cost of the downloading made by the user may be reduced.

### CROSS-REFERENCE TO RELATED APPLICATIONS

This application is a continuation of International Application No. PCT/CN2012-070524, filed on Jan. 28, 2012. This application claims the benefit and priority of Chinese Patent Application No. 201110032532.X, filed Jan. 27, 2011. The entire disclosures of each of the above applications are incorporated herein by reference.

### FIELD

The present disclosure relates to image processing technologies and to a method and device for implementing a generic icon with multiple display modes.

### BACKGROUND

This section provides background information related to the present disclosure which is not necessarily prior art.

A terminal device, especially a mobile terminal device, usually runs in different environments, such as an outdoor environment, an indoor environment, a day environment and a night environment. In order to make icons displayed on a display screen of the terminal device satisfy comfort requirements in different environments put forward by a user, icons in different display modes are provided for the user targeting at different environments. For instance, an icon in a normal mode needs to be adopted in the day environment, while an icon in a night mode needs to be adopted in the night environment. Multiple sets of skins applicable to different environments need to be prepared. Each skin set corresponds to a specific environment or display mode and includes multiple icons.

The following description addresses using the icons in the normal mode and night mode of the existing mobile terminal device, for example.

Referring to FIGS. 1 and 2, FIG. 1 is a schematic diagram illustrating an icon displayed in a normal mode of an existing mobile terminal device, and FIG. 2 is a schematic diagram illustrating an icon displayed in a night mode of the existing mobile terminal device. Requirements put forward by the user for viewing the icon in the normal mode are different from those for viewing the icon in the night mode. In the normal mode, the icon merely needs to guarantee that the icon may be normally identified and operated by the user. However, in the night mode, the icon not only needs to guarantee the normal identification, but also needs to consider the comfort of the user's eyes, so that the icon cannot glare, should have moderate colors and fuse with a dark environment. Therefore, images for forming a display icon are different, and operations need to be carried out on the basis of images in need of different processing. Due to problems existing in performances of a mobile terminal system and development tools, at the present stage, transparency and shadows of some icons and images on the mobile terminal software cannot be implemented with a full-transparent image in a Portable Network Graphic (PNG) format, bits of which are more than 24. Therefore, in order to present multiple sets of skins, the corresponding multiple sets of skins need to be stored. A corresponding mask layer needs to be provided for each translucent or transparent display icon. For instance, if skin images of software A are cut and there are forty images in need of the transparent and translucent processing, in order to obtain a design effect of a User Interface (UI), a set of corresponding masks need to be provided for the forty images to generate the display icons. Therefore, an installation packet of the skin of the software A includes eighty images. In order to increase new skins, images, the color of which corresponds to the newly-added skin and masks thereof need to be cut.

Using icons set in FIGS. 1 and 2 for example, the method for generating the display icon in the normal mode and the display icon in the night mode is described hereafter.

Referring to FIG. 3, FIG. 3 is a flow chart illustrating an existing method for generating a display icon in a normal mode. The flow includes the following blocks.

At block 301, an original image icon in a normal mode is preset and stored. In this block, the background of the original image icon in the normal mode is configured as white, a color value is #ffffff, and the white is defined as opaque.

At block 302, the color of the original image icon in the normal mode is adjusted to obtain a mask layer icon in the normal mode, and the mask layer icon in the normal mode is stored. In this block, the color of the original image icon in the normal mode is adjusted and processed to obtain the mask layer icon in the normal mode. The background of the mask layer icon in the normal mode is configured as black. The color value is #000000, and black is defined as full-transparent.

The above block 301 to block 302 are executed at the network side. After obtaining relevant processing images in relevant display modes, the relevant processing images are encapsulated into a skin installation package at the network side, and sent to the mobile terminal side.

At block 303, calculations are performed on the original image icon in the normal mode and mask layer icon in the normal mode to obtain a display icon in the normal mode. In this block, the mobile terminal device receives the skin installation package. After the calculation is performed on the original image icon in the normal mode and the mask layer icon in the normal mode, i.e. the translucent effect is implemented with gray color in the mask, so that the original image icon after the transparent processing is overlapped with the background, a transparent background layer icon with a 256-color channel is obtained. The display icon in the normal mode which may be directly seen by the user is presented.

Referring to FIG. 4, FIG. 4 is a schematic diagram illustrating an existing process for generating the display icon “set-up” in the normal mode. In FIG. 4, A is the mask layer icon in the normal mode, B is the original image icon in the normal mode, and C is the display icon in the normal mode.

In the night mode, the flow for generating the display icon is similar to that in FIG. 3. It differs from FIG. 3, in that the factors considered when generating the display icon in the night mode are different, color adjustment and screenshot needs to be performed on the original image icon in the normal mode to obtain the mask layer icon in the night mode and the original image icon in the night mode. A calculation is performed on the obtained original image icon in the night mode and the mask layer icon in the night mode to obtain the display icon in the night mode.

Referring to FIG. 5, FIG. 5 is a schematic diagram illustrating an existing method for generating the display icon “set-up” in the night mode. In FIG. 5, D is the mask layer icon in the night mode, E is the original image icon in the night mode, and F is the display icon in the night mode. A differs from D in the adjustment of the color and the level that the transparency is processed. B also differs from E in the adjustment of the color and the level that the transparency is processed.

The existing method for generating the display icon in the normal mode and the display icon in the night mode needs to adjust the color of the image, and respectively performs image cut to obtain the corresponding original image icon and mask layer icon. Then, the mobile terminal device performs calculation to obtain the display icons in the skin. In this way, the skin installation package has to include many images, and a large amount of memory resources of the mobile terminal device need to be consumed. At the same time, the size of the installation package is large, which increases the overhead for downloading wireless resources and the cost of the users.

### SUMMARY

This section provides a general summary of the disclosure, and is not a comprehensive disclosure of its full scope or all of its features.

A method for implementing a generic icon with multiple display modes, to reduce the number of the images in the skin installation package and the cost of the downloading made by the user.

A device for implementing a generic icon with multiple display modes, to reduce the number of the images in the skin installation package and the cost of the downloading made by the user.

A method is provided for implementing a generic icon with multiple display modes, including:
presetting an original image icon in a Bitmap format;
performing translucent processing on the original image icon according to preset display modes, and obtaining mask layer icons satisfying requirements of each of the display modes; and
encapsulating the original image icon and the mask layer icons obtained by performing the translucent processing on the original image icon into a skin installation package, and sending the skin installation package.

After sending the skin installation package, the method further includes receiving, by a mobile terminal device, the skin installation package, performing calculation on the original image icon and the mask layer icons corresponding to each of the display modes, and obtaining a display icon corresponding to the each of the display modes. A background of the original image icon is configured as white, and the white is defined as full-transparent.

The display modes include a normal mode and a night mode.

The method for performing the translucent processing on the original image icon includes:
reading the stored original image icon, adjusting transparency of the original image icon to make an image effect meet user's requirements of viewing an image in the normal mode, obtaining a mask layer icon in the normal mode, setting a background of the mask layer icon in the normal mode as black, and defining the black as full-transparent; and
reading the stored original image icon, adjusting the transparency of the original image icon, to make image effect meet user's requirements of viewing the image in the night mode, obtaining a mask layer icon in the night mode, and setting a background of the mask layer icon in the night mode as the black, wherein an image of the mask layer icon in the night mode is gray after the translucent processing.

Images in the skin installation package include: the original image icon, the mask layer icon in the normal mode and the mask layer icon in the night mode.

The method for performing the calculation on the original image icon and the mask layer icons corresponding to each of the display modes, and obtaining the display icon corresponding to each of the display modes includes:
reading the original image icon and a mask layer icon in a normal mode obtained by performing the translucent processing on the original image icon, performing the calculation, and obtaining a display icon in the normal mode; and
reading the original image icon and a mask layer icon in a night mode obtained by performing the translucent processing on the original image icon, performing the calculation, and obtaining the display icon in the night mode.

A device for implementing a generic icon with multiple display modes includes: an original image icon storage module, a display mode strategy storage module, a mask layer icon processing module and an encapsulation module, wherein
the original image icon storage module is configured to store an obtained original image icon in a Bitmap format;
the display mode strategy storage module is configured to store each preset display mode strategy;
the mask layer icon processing module is configured to read the original image icon from the original image icon storage module and perform translucent processing on the original image icon according to the each display mode strategy stored in the display mode strategy storage module, obtain mask layer icons meeting requirements of each display mode, and send the mask layer icons to the encapsulation module; and
the encapsulation module is configured to encapsulate the original image icon stored in the original image icon storage module and the received mask layer icons into a skin installation package, and send the skin installation package.

The mask layer icon processing module includes: a normal mode mask layer icon processing sub-module and a night mode mask layer icon processing sub-module; wherein
the normal mode mask layer icon processing sub-module is configured to perform the translucent processing on the original image icon read from the original image icon storage module according to a normal display mode strategy stored in the display mode strategy storage module, obtain a mask layer icon in a normal mode, and send the mask layer icon in the normal mode to the encapsulation module; and
the night mode mask layer icon processing sub-module is configured to perform the translucent processing on the original image icon read from the original image icon storage module according to a night display mode strategy stored in the display mode strategy storage module, obtain a mask layer icon in a night mode, and send the mask layer icon in the night mode to the encapsulation module.

A method and device for implementing a generic icon with multiple display modes is provided. An original image icon in a Bitmap format is preset, translucent processing is performed on the original image icon according to preset display modes, a mask layer icon satisfying requirements of each of the display modes is obtained, the original image icon and the mask layer icon obtained by translucent processing are encapsulated into a skin installation package, and the skin installation package is sent to the mobile terminal device. Therefore, by performing the translucent processing on the original image icon according to the display modes, the mask layer icon with multiple display modes may be obtained by performing the transparent processing on the original image icon. While the original image icon in multiple display modes may share the same icon, by which the number of the images in the software installation package and the cost of the downloading made by the user may be reduced.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram illustrating icons displayed on an existing mobile terminal device in a normal mode;

FIG. 2 is a schematic diagram illustrating icons displayed on the existing mobile terminal device in a night mode;

FIG. 3 is a flow chart illustrating an existing method for generating a display icon in a normal mode;

FIG. 4 is a schematic diagram illustrating an existing method for generating display icon “set-up” in the normal mode;

FIG. 5 is a schematic diagram illustrating an existing method for generating the display icon “set-up” in the night mode;

FIG. 6 is a flow chart illustrating a method for implementing a generic icon with multiple display modes;

FIG. 7 is a schematic diagram illustrating how the display icon “set-up” in the normal mode is generated in accordance with an embodiment of the present invention;

FIG. 8 is a schematic diagram illustrating how the display icon “set-up” in the night mode is generated in accordance with an embodiment of the present invention; and

FIG. 9 is a schematic diagram illustrating structure of a device for generating a generic icon with multiple display modes.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

In the conventional method, due to personalized needs of the mobile terminal device, software User Interface (UI) has many skins. A display icon in each mode needs to perform calculations on an original icon and a mask layer icon in the corresponding mode, so that a skin installation package includes numerous images, and the cost of the downloading made by the user is high. In various embodiments, taking into account that a Bitmap (BMP) file has an image file format unrelated to a hardware device. BMP gray has a translucent characteristic. Based on a same BMP original image icon, icon brightness suitable for different modes is obtained via changing transparency of the BMP original image icon. Therefore, processing, such as color adjustment and image cut needs not to be performed on the original image icon, which may satisfy the viewing requirements put forward by the user on the display icons in different modes.

Referring to FIG. 6, FIG. 6 is a flow chart illustrating a method for implementing a generic icon with multiple display modes. The flow includes the following.

In block 601, an original image icon in a BMP format is pre-set. In this block, the background of the original image icon is pre-set as white. The color value is #ffffff, and the white is defined as full-transparent.

In block 602, translucent processing is performed on the original image icon according to the preset display modes to obtain mask layer icons satisfying requirements of each of the display modes. In this block, the preset display mode includes the normal mode and the night mode. Certainly, in practice, along with the change of the users' requirements and the enhancement of the users' comfort requirements, more modes may be set. The requirements put forward by each display mode on the images are preset.

Taking the preset display modes including the normal mode and the night mode, for example, the method for respectively performing translucent processing on the original image icon includes the following.

The translucent processing in the normal mode includes reading the stored original image icon, and adjusting the transparency of the original image icon to make an image effect satisfy the requirements put forward by the user for viewing the image in the normal mode and obtaining the mask layer icon in the normal mode. The background of the mask layer in the normal mode is configured as black, the color value is #000000, and the black is defined as full-transparent.

The translucent processing in the night mode includes reading the stored original image icon, and adjusting the transparency of the original image icon to make the image effect satisfy the requirements put forward by the user for viewing the image in the night mode and obtaining the mask layer icon in the night mode. A background of the mask layer icon in the night mode is configured as black, the color value is #000000, and an image of the mask layer icon in the night mode is gray after the translucent processing. The gray between the white and the black is defined as translucency. The characteristic that different color depth of the gray represents different transparency is utilized. The original image icon in the normal mode, i.e. the stored original image icon is adopted, and then the transparency of the original image icon is adjusted to make it suitable for the brightness of the display icon in the night mode. Then, the image with the adjusted transparency is processed. For instance, if the black is configured as opaque and the white is configured as full-transparent, the icon with the adjusted transparency is filled with the while color, and a black image layer is added behind the icon to obtain a gray mask. Therefore, in the night mode, the transparency of the corresponding icon may be implemented using the obtained gray mask, to achieve the purpose that the night mode and the normal mode use a same original image icon.

In practice, the original image icon and the mask layer icons obtained by the translucent processing may be stored.

In block 603, the original image icon and the mask layer icons obtained by the translucent processing are encapsulated into the skin installation package and the skin installation package is sent to the mobile terminal device. In this block, the images in the skin installation package include the original image icon, the mask layer icon in the normal mode and the mask layer icon in the night mode. Different icons may be distinguished with identifiers. Compared with the images included in the existing skin installation package, the original image icon in the night mode is not included in the present installation package.

Therefore, as for the skin installation package with n (n is a natural number) display modes, and the number of sets of the images in the skin installation package is:

N=2n−(n−1)=n+1

In the formula, N is the number of sets of the images in the skin installation package with n modes.

Wherein, n is the natural number, and 2n denotes the number of sets of the images in the existing skin installation package with n modes.

For example, as for the skin installation package with two display modes, i.e. the normal mode and the night mode, the number of the image sets is 3 sets, i.e. one set of original image icon, one set of mask layer icon in the normal mode and one set of mask layer icon in the night mode. As for the existing skin installation package with two modes, i.e. the normal mode and the night mode, the number of the image sets is 4 sets, i.e. one set of the original image icon in the normal mode, one set of the original image icon in the night mode, one set of the mask layer icon in the normal mode and one set of the mask layer icon in the night mode. Compared with the existing skin installation package, the skin installation package does not include the original image icon in the night mode, by which a quarter of images are reduced. If there is one type of display mode included in the skin installation package, the capacity of the skin installation package is the same as that in the conventional method, while, as for the skin installation package with two or more display modes, the capacity of the skin installation package may be greatly reduced.

After the mobile terminal device receives the skin installation package, the method further includes the following.

In block 604, the skin installation package is received. Calculation is performed on the original image icon and the mask layer icons corresponding to each of the display modes, and a display icon corresponding to each of the display modes are obtained.

In this block, after performing the calculation on the original image icon and the corresponding mask layer icons, i.e. the translucent effect is achieved with the gray in the mask, and the icon of the original image icon after the transparent processing is overlapped with the background of a mask layer icon. A transparent background layer icon with the 256-color channel is obtained. The display icons corresponding to each of the display modes which may be directly seen by the user are presented to the user.

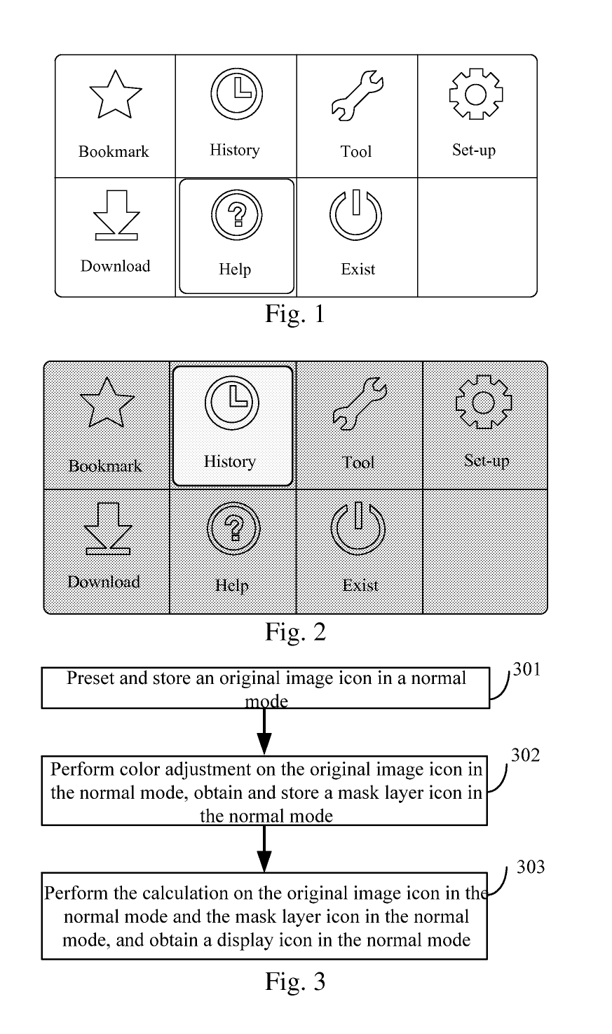

In view of the above, as for the normal mode, the original image icon and the mask layer icon in the normal mode obtained by performing the translucent processing on the original image icon are read from the skin installation package. Calculation is then performed on the original image icon and the corresponding mask layer icon in the normal mode, and the display icon in the normal mode is obtained. The display icon which may be directly seen by the user is presented to the user. For instance, as for a bookmark display icon in FIG. 1, a bookmark original image icon and a bookmark mask layer icon in the normal mode are read from the skin installation package. Calculation is performed and a bookmark display icon is obtained. Other display icons, such as history, tool, set-up, download, help, and release may be obtained with the same method as that for obtaining the bookmark display icon.

As for the night mode, the original image icon and the mask layer icon in the night mode obtained by performing the translucent processing on the original image icon are read from the skin installation package. Calculation is performed on the original image icon and the corresponding mask layer icon in the night mode to obtain the display icon in the night mode. The display icon in the night mode which may be directly seen by the user is presented to the user.

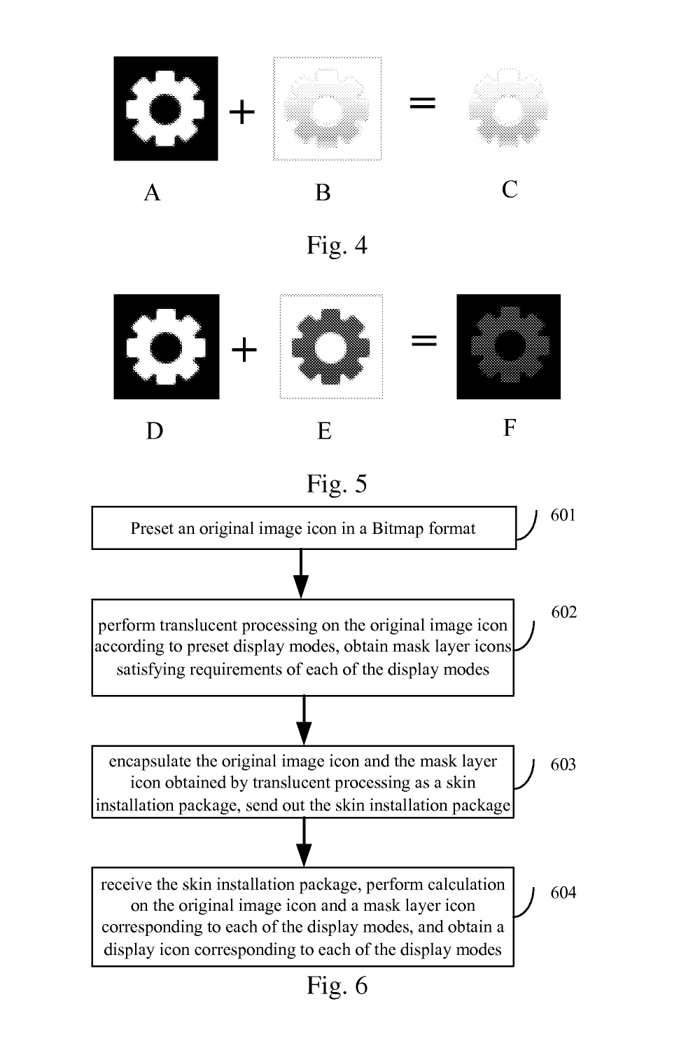

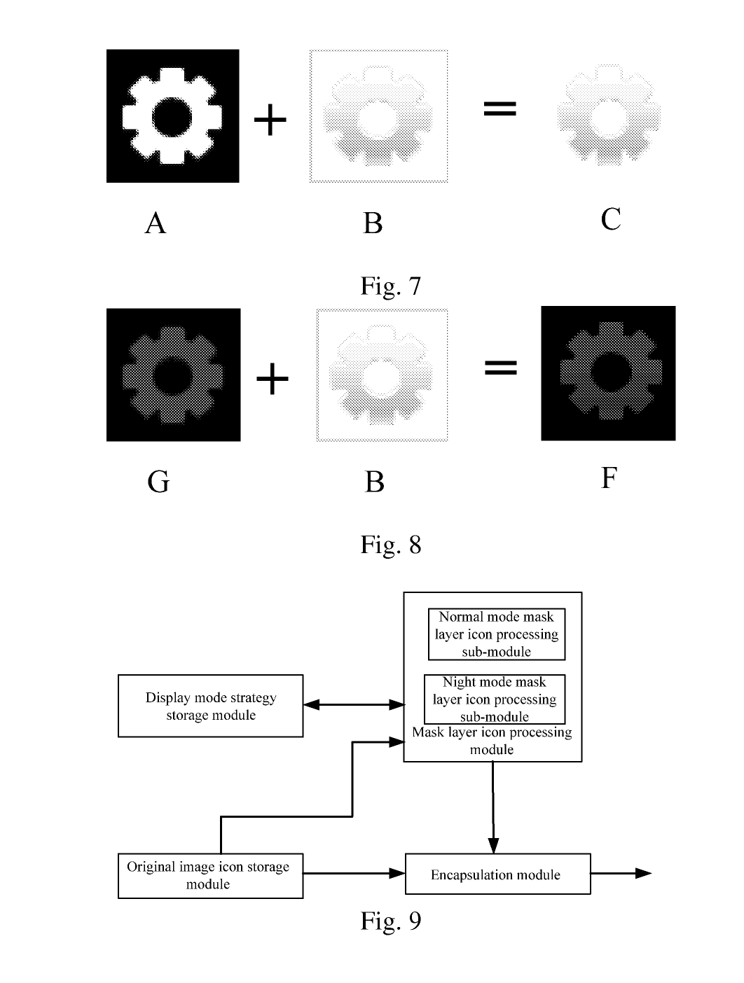

Referring to FIG. 7, FIG. 7 is a schematic diagram illustrating a process for generating the display icon “set-up” in the normal mode in accordance with various embodiments. In FIG. 7, A is the mask layer icon in the normal mode, B is the original image icon and the C is the display icon in the normal mode. FIG. 7 differs from FIG. 4 in that the mask layer icon in the normal mode in FIG. 7 is obtained by performing the translucent processing on the original image icon, while the mask layer icon in the normal mode in FIG. 4 is obtained by performing the color processing and image cut on the original image icon.

Referring to FIG. 8, FIG. 8 is a schematic diagram illustrating a process for generating the display icon “set-up” in the night mode in accordance with various embodiments. In FIG. 8, G is the mask layer icon in the night mode, B is the original image icon and F is the display icon in the night mode. FIG. 8 differs from FIG. 5 in that the mask layer icon in the night mode in FIG. 8 is obtained by performing the translucent processing on the original image icon. The original image icon in the night mode and the original image icon in the normal mode use the same icon. While the mask layer icon in the night mode and the original image icon in the night mode in FIG. 5 are obtained by performing the color processing and image cut on the original image icon in the normal mode.

In the method for implementing the generic icon with multiple modes provided by various embodiments, the original image icon in the BMP format is preset and stored. The translucent processing is performed on the original image icon according to the preset display mode, and mask layer icons satisfying the requirements of each display mode are obtained and stored. The stored original image icon and the mask layer icons obtained by the translucent processing are encapsulated into the skin installation package and the skin installation package is sent to the mobile terminal device. Therefore, the translucent processing is respectively performed on the original image icon according to the display modes, and the mask layer icons in the night mode and the day mode may be obtained by performing the transparent processing on the original image icon. The original image icon in the night mode may share the same original image icon with the original image icon in the day mode, which reduces the number of the images in the software installation package, reduces the capacity of the installation package, saves the overhead of the wireless network resources, and effectively reduces the cost of the downloading made by the user. Meanwhile, the images consuming too much running memory of the mobile terminal device is avoided, and the program is user-friendly.

Referring to FIG. 9, FIG. 9 is a schematic diagram illustrating structure of a device for implementing a generic icon with multiple display modes. The device includes an original image icon storage module, a display mode strategy storage module, a mask layer icon processing module and an encapsulation module.

The original image icon storage module stores the obtained original image icons in BMP format.

The display mode strategy storage module stores each preset display mode strategy.

In various embodiments, the display mode strategy is a corresponding relationship between a display icon obtained by calculation and original image icon transparency. After performing the translucent processing on the original image icon according to the corresponding relationship and the calculation, the obtained display icon may satisfy the users' comfort demands.

The mask layer icon processing module performs the translucent processing on the original image icon read from the original image icon storage module according to each display mode strategy stored in the display mode strategy storage module, obtains the mask layer icons satisfying each display mode demand, and transmits the mask layer icons to the encapsulation module.

The encapsulation module encapsulates the original image icon stored in the original image icon storage module and the received mask layer icon into a skin installation skin, and sends the skin installation skin to the mobile terminal device.

After receiving the skin installation package, the mobile terminal device respectively performs calculation on the original image icon and the mask layer icon corresponding to a display mode, and obtains the display mode corresponding to the display mode.

In various embodiments, the mask layer icon processing module includes a normal mode mask layer icon processing sub-module and a night mode mask layer icon processing sub-module.

The normal mode mask layer icon processing sub-module performs the translucent processing on the original image icon read from the original image icon storage module according to a normal display mode strategy stored in the display mode strategy storage module, obtains a mask layer icon in a normal mode, and sends the mask layer icon in the normal mode to the encapsulation module.

The night node mask layer icon processing sub-module performs the translucent processing on the original image icon read from the original image icon storage module according to a night display mode strategy stored in the display mode strategy storage module, obtains a mask layer icon in a night mode, and sends the mask layer icon in the night mode to the encapsulation module.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for implementing a generic icon with multiple display modes, comprising:
presetting an original image icon in a Bitmap format;
performing translucent processing on the original image icon according to preset display modes, and obtaining mask layer icons satisfying requirements of each of the display modes; and
encapsulating the original image icon and the mask layer icons obtained by performing the translucent processing on the original image icon into a skin installation package, and sending the skin installation package.

2. The method according to claim 1, after sending the skin installation package, further comprising:
receiving, by a mobile terminal device, the skin installation package, performing calculation on the original image icon and the mask layer icons corresponding to each of the display modes, and obtaining a display icon corresponding to the each of the display modes.

3. The method according to claim 2, wherein a background of the original image icon is configured as white, and the white is defined as full-transparent.

4. The method according to claim 3, wherein the display modes comprise a normal mode and a night mode.

5. The method according to claim 4, wherein performing the translucent processing on the original image icon comprises:
reading the stored original image icon, adjusting transparency of the original image icon to make an image effect meet user's requirements of viewing an image in the normal mode, obtaining a mask layer icon in the normal mode, setting a background of the mask layer icon in the normal mode as black, and defining the black as full-transparent; and
reading the stored original image icon, adjusting the transparency of the original image icon, to make image effect meet user's requirements of viewing the image in the night mode, obtaining a mask layer icon in the night mode, and setting a background of the mask layer icon in the night mode as the black, wherein an image of the mask layer icon in the night mode is gray after the translucent processing.

6. The method according to claim 5, wherein images in the skin installation package comprise: the original image icon, the mask layer icon in the normal mode and the mask layer icon in the night mode.

7. The method according to claim 4, wherein performing the calculation on the original image icon and the mask layer icons corresponding to each of the display modes, and obtaining the display icon corresponding to each of the display modes comprises:
reading the original image icon and a mask layer icon in a normal mode obtained by performing the translucent processing on the original image icon, performing the calculation, and obtaining a display icon in the normal mode; and
reading the original image icon and a mask layer icon in a night mode obtained by performing the translucent processing on the original image icon, performing the calculation, and obtaining the display icon in the night mode.

8. A device for implementing a generic icon with multiple display modes, comprising: an original image icon storage module, a display mode strategy storage module, a mask layer icon processing module and an encapsulation module, wherein
the original image icon storage module is configured to store an obtained original image icon in a Bitmap format;
the display mode strategy storage module is configured to store each preset display mode strategy;
the mask layer icon processing module is configured to read the original image icon from the original image icon storage module and perform translucent processing on the original image icon according to the each display mode strategy stored in the display mode strategy storage module, obtain mask layer icons meeting requirements of each display mode, and send the mask layer icons to the encapsulation module; and
the encapsulation module is configured to encapsulate the original image icon stored in the original image icon storage module and the received mask layer icons into a skin installation package, and send the skin installation package.

9. The device according to claim 8, wherein the mask layer icon processing module comprises: a normal mode mask layer icon processing sub-module and a night mode mask layer icon processing sub-module; wherein
the normal mode mask layer icon processing sub-module is configured to perform the translucent processing on the original image icon read from the original image icon storage module according to a normal display mode strategy stored in the display mode strategy storage module, obtain a mask layer icon in a normal mode, and send the mask layer icon in the normal mode to the encapsulation module; and
the night mode mask layer icon processing sub-module is configured to perform the translucent processing on the original image icon read from the original image icon storage module according to a night display mode strategy stored in the display mode strategy storage module, obtain a mask layer icon in a night mode, and send the mask layer icon in the night mode to the encapsulation module.
